(19) United States
(12) Patent Application Publication
(10) Pub. No.: US 2026/0081735 A1
(43) Pub. Date: Mar. 19, 2026

(54) PDSCH PROCESSING TIME ENHANCEMENT TO SUPPORT UPLINK TRANSMIT SWITCHING

(71) Applicant: APPLE INC., Cupertino, CA (US)

(72) Inventors: Haitong Sun, Cupertino, CA (US); Chunhai Yao, Beijing (CN); Hong He, San Jose, CA (US); Yang Tang, San Jose, CA (US); Dawei Zhang, Saratoga, CA (US); Leilei Song, Beijing (CN); Wei Zeng, San Diego, CA (US); Amir Aminzadeh Gohari, Sunnyvale, CA (US); Ankit Bhamri, Bad Nauheim (DE); Amir Farajidana, Sunnyvale, CA (US)

(21) Appl. No.: 19/110,703

(22) PCT Filed: Sep. 29, 2022
(86) PCT No.: PCT/CN2022/122832

§ 371 Date: Mar. 11, 2025

(51) Int. Cl. H04L 5/00; H04W 72/1263

(52) U.S. Cl. CPC H04L 5/0044; H04L 5/0055; H04W 72/1263

(57) ABSTRACT

Systems and methods for physical downlink shared channel (PDSCH) processing time enhancement to support uplink (UL) transmit (Tx) switching are described. In some embodiments, a PDSCH processing time, T_{proc,1}, is determined using an UL Tx switch processing time, T_{switch}, corresponding to a physical uplink shared channel (PUSCH) preparation time, T_{proc,2}, used at a UE. In some embodiments, a T_{proc,1} is determined using a PDSCH UL Tx switch processing time, T_{switch,PDSCH}, that is determined using a T_{switch} corresponding to a T_{proc,2} used at a UE. In some embodiments, a T_{proc,2} is compared to a time between an end of a downlink control information (DCI) scheduling a PDSCH and a beginning of a physical uplink control channel (PUCCH) having hybrid automatic repeat request acknowledgement (HARQ-ACK) signaling for a PDSCH to determine treatment of the PUCCH. In some embodiments, a d_{1,1} component of T_{proc,1} is relaxed based on a T_{switch}.

### TECHNICAL FIELD

This application relates generally to wireless communication systems, including uplink (UL) transmit (Tx) switching for multiple carrier operation.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHZ (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A and FIG. 1B are timing diagrams comparing PUSCH preparation time and PDSCH processing time.

FIG. 2 is a table illustrating UE capability parameters that may be reported by a UE to a base station according to one embodiment.

FIG. 3 is a flowchart illustrating a method of a UE according to one embodiment.

FIG. 4 is a flowchart illustrating a method of a RAN according to one embodiment.

FIG. 5 is a table illustrating UE capability parameters that may be reported by a UE to a base station according to one embodiment.

FIG. 6 is a flowchart illustrating a method of a UE according to one embodiment.

FIG. 7 is a flowchart illustrating a method of a RAN according to one embodiment.

FIG. 8 is a flowchart illustrating a method of a UE according to one embodiment.

FIG. 9 is a flowchart illustrating a method of a RAN according to one embodiment.

FIG. 10 is a flowchart illustrating a method of a UE according to one embodiment.

FIG. 11 is a flowchart illustrating a method of a RAN according to one embodiment.

FIG. 12 illustrates an example architecture of a wireless communication system, according to embodiments disclosed herein.

FIG. 13 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In certain wireless systems (e.g., 3GPP Release 16 (Rel-16)), an uplink (UL) transmit (Tx) switch allows power amplifier (PA) sharing between different component carriers. To accommodate the additional processing time for UL Tx switch, a UE can report the additional time for UL Tx switch to a base station. For example, the UE may report a parameter (e.g., uplinkTxSwitchingPeriod) in an information element (IE) sent to the base station to indicate UL Tx switch processing time T_{switch} (e.g., one of {35 μs, 140 μs, 210 μs}).

The value of the UL Tx switch processing time T_{switch} may be added to the UL processing time from scheduling downlink control information (DCI) for physical channels or signals such as DCI scheduled physical uplink shared channel (PUSCH) (e.g., T_{proc,2}), DCI triggered aperiodic sounding reference signal (SRS), physical downlink control channel (PDCCH) order (DCI) triggered physical random access channel (PRACH) transmission, DCI triggered aperiodic channel state information (CSI) report on PUSCH, and/or UL uplink control information (UCI) multiplexing. However, current wireless systems do not add the value of the UL Tx switch processing time T_{switch} to physical downlink shared channel (PDSCH) processing time (e.g., T_{proc,1}) because it was thought that T_{proc,1} may be counted from the end of PDSCH to the beginning of a hybrid automatic repeat request (HARQ) acknowledgment (ACK), which may give sufficient margin if the end of scheduling DCI is considered. However, analysis by the present inventors has determined that such margin may not be sufficient.

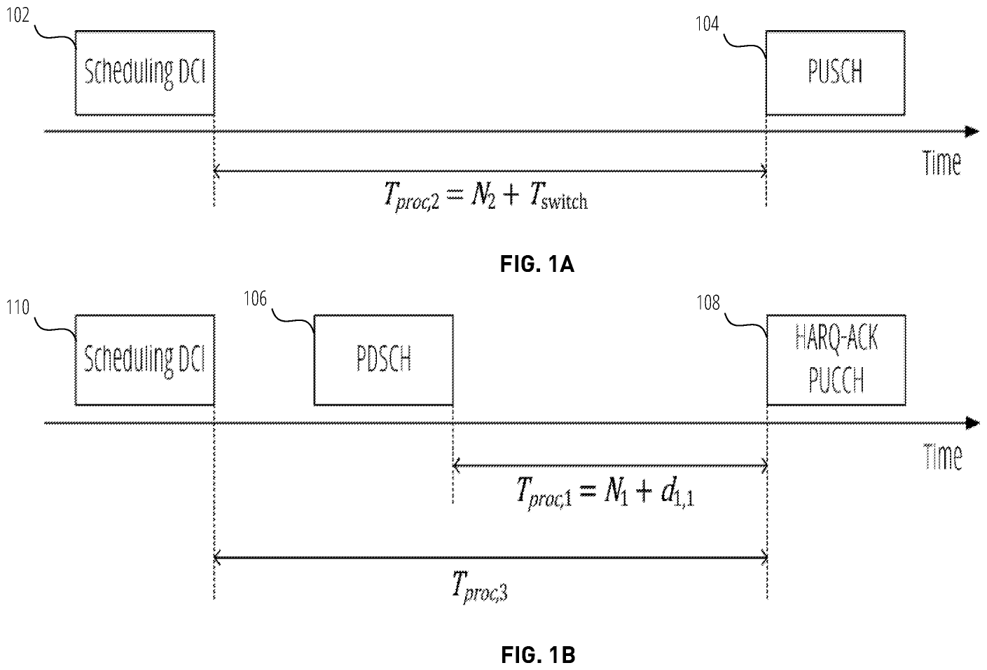

For example, FIG. 1A and FIG. 1B are timing diagrams comparing PUSCH preparation time and PDSCH processing time. FIG. 1A illustrates the value of the UL Tx switch processing time T_{switch} added to the UL processing or preparation time N₂ (i.e., number of symbols) from the end of a scheduling DCI 102 to the beginning of a corresponding PUSCH 104 (i.e., T_{proc,2}=N₂+T_{switch}).

For PDSCH, FIG. 1B illustrates the processing time T_{proc,1} from the end of a PDSCH 106 to the start of a corresponding hybrid automatic repeat request acknowledgement (HARQ-ACK) physical uplink control channel (PUCCH) 108. As shown, the processing time T_{proc,1} may correspond to a number of symbols N₁ plus a relaxation component d_{1,1} (i.e., T_{proc,1}=N₁+d_{1,1}). The relaxation component d_{1,1} may include, for example, one or more symbols to account for situations where the PDSCH 106 may occur too close to, or may overlap with, the scheduling DCI 110. Thus, the relaxation component d_{1,1} allows time for the scheduling DCI 110 to be decoded so as to determine the timing of the HARQ-ACK PUCCH 108.

FIG. 1B also illustrates the time T_{proc,3} between the end of the scheduling DCI 110 and the start of the HARQ-ACK PUCCH 108. For a worst case (e.g., a shortest duration or when the PDSCH 106 overlaps with the scheduling DCI 110), T_{proc,3} is only X symbols more than N₂ (i.e., T_{proc,3}=N₂+X symbols). For a subcarrier spacing (SCS) of 15 kilohertz (kHz), X=2 for the worst case, which is 143 μs and is not enough to cover T_{switch}={210 μs}. As another example, for an SCS of 30 kHz, X=2 for the worst case, which is 71 μs and is not enough to cover T_{switch}={140 μs, 210 μs}. Further, for an SCS of 60 kHz, X=−2 for the worst case, which is-36 μs and is not enough to cover any of T_{switch}={35 μs, 140 μs, 210 μs}. Thus, the timing margin is not sufficient in these examples for the HARQ-ACK PUCCH 108 triggered by the reception of the PDSCH 106 scheduled by the scheduling DCI 110. While for many possible PDSCH scheduling the duration between the scheduling DCI 110 and the HARQ-ACK PUCCH 108 is sufficient for UL Tx switching, for the worst cases the duration is insufficient.

Thus, embodiments disclosed herein provide solutions to address PDSCH processing time relaxation to support UL switching. Certain embodiments, for example, relax the PDSCH processing time with T_{switch}. Other embodiments may relax PDSCH processing time with a new gap.

Relax PDSCH Processing Time with T_{switch}

In one embodiment, the PDSCH processing time T_{proc,1} is relaxed using a T_{switch} value used for a determination of a PUSCH preparation time T_{proc,2}, as described herein. In certain such embodiments, the UE sends a UE capability message to the base station to indicate that the UE uses the UL Tx switch processing time T_{switch} to calculate the PDSCH processing time. For example, the T_{switch} may be reported in uplinkTxSwitchingPeriod-r16 and/or uplinkTxSwitchingPeriod2T2T-r17, where the candidate value is {35 μs, 140 μs, 210 μs}. In addition, or in other embodiments, T_{switch} may be added to T_{proc,1} (see, e.g., 3GPP Technical Specification (TS) 38.214) as:

$${T}_{p r o c , 1} = ( {N}_{1} + {d}_{1.1} + {d}_{2} ) ( 2048 + 1 \; 44 ) \cdot {κ2}^{- μ} \cdot {T}_{c} + {T}_{e x t} + {T}_{s w i t c h} ,$$

where μ is an index value corresponding to SCS configuration, κ is a ratio between Tₛ and T_{c}, T_{c} is the basic time unit for NR. Tₛ is the basic time unit for LTE, Text is a cyclic prefix extension, and d_{1,1} and d₂ are relaxation times (symbols).

In one embodiment, when PDSCH processing time T_{proc,1} is relaxed using T_{switch}, a new UE capability is introduced to indicate whether this relaxation is needed or not. The capability may be reported, for example, as a 3GPP Rel-16 UE capability, a 3GPP Rel-17 UE capability, or a 3GPP Rel-18 UE capability.

In one embodiment, when PDSCH processing time T_{proc,1} is relaxed using T_{switch}, and a new UE capability is introduced to indicate whether this relaxation is needed or not, the capability indication message may be per band combination (BC) and indicates that the UE uses the T_{switch} to calculate the PDSCH processing time within the BC, or the capability indication message may be per UE and indicates whether the UE always uses the T_{switch} to calculate the PDSCH processing time.

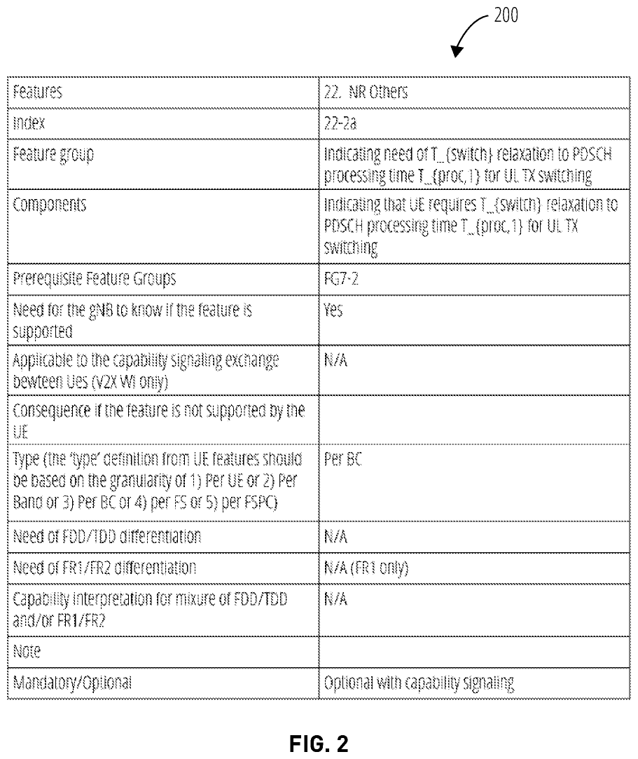

For example, FIG. 2 illustrates a table 200 of UE capability parameters that may be reported by a UE to a base station according to one embodiment. For the reported capability, the illustrated example indicates: features (e.g., for “22. NR other”); an index (e.g., “22-2a”); a feature group (e.g., indicating need of T_{switch} relaxation to PDSCH processing time T_{proc,1} for UL Tx switching); components (e.g., indicating that UE requires T_{switch} relaxation to PDSCH processing time T_{proc,1} for UL Tx switching); prerequisite feature groups (e.g., “FG7-2”); whether there is a need for the base station (e.g., gNB) to know if the feature is supported (e.g., yes); whether the indication is applicable to signaling exchange between UEs (e.g., for vehicle-to-everything (V2X) implementations) (e.g., not applicable “N/A”); a consequence if the feature is not supported by the UE; a Type (the ‘type’ definition from UE features may be based on the granularity of 1) Per UE or 2) Per Band or 3) Per BC or 4) Per Feature Set (FS) or 5) Per Feature Set Per Component-Carrier (FSPC)) (e.g., per BC in this example); whether there is a need for frequency division duplexing (FDD) or time divisional duplexing (TDD) differentiation (e.g., N/A); whether there is a need for FR1 or FR2 differentiation (e.g. N/A); whether there is capability interpretation for FDD/TDD and/or FR1/FR2 (e.g., N/A); Note (if any); and/or whether the capability is mandatory or optional (e.g., optional with capability signaling).

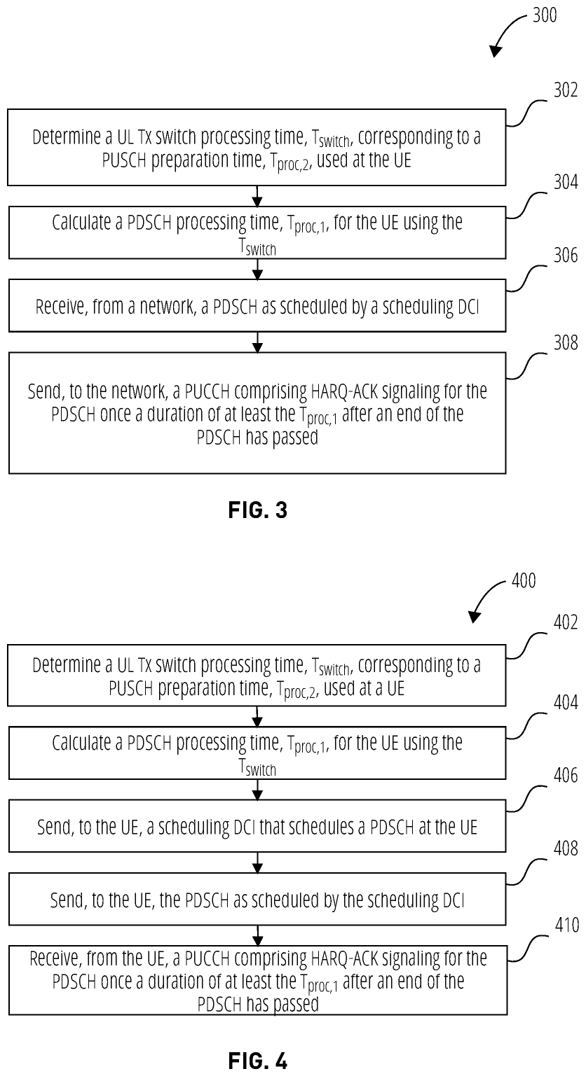

FIG. 3 is a flowchart illustrating a method 300 of a UE according to one embodiment. In block 302, the method 300 includes determining a UL Tx switch processing time, T_{switch}, corresponding to a PUSCH preparation time, T_{proc,2}, used at the UE. In block 304, the method 300 includes calculating a PDSCH processing time, T_{proc,1}, for the UE using the T_{switch}. In block 306, the method 300 includes receiving, from a network, a PDSCH as scheduled by a scheduling DCI. In block 308, the method 300 includes sending, to the network, a PUCCH comprising HARQ-ACK signaling for the PDSCH once a duration of at least the T_{proc,1} after an end of the PDSCH has passed.

In one embodiment, the method 300 further includes sending, to the network, a capability indication message indicating that the UE uses the T_{switch} to calculate the PDSCH processing time. The capability indication message may indicate that the UE uses the T_{switch} to calculate the PDSCH processing time within a band combination. Alternatively, the capability indication message indicates that the UE always uses the T_{switch} to calculate the PDSCH processing time.

In one embodiment of the method 300, the T_{switch} comprises one of 35 μs, 140 μs, and 210 μs.

FIG. 4 is a flowchart illustrating a method 400 of a RAN according to one embodiment. In block 402, the method 400 includes determining a UL Tx switch processing time, T_{switch}, corresponding to a PUSCH preparation time, T_{proc,2}, used at a UE. In block 404, the method 400 includes calculating a PDSCH processing time, T_{proc,1}, for the UE using the T_{switch}. In block 406, the method 400 includes sending, to the UE, a scheduling DCI that schedules a PDSCH at the UE. In block 408, the method 400 includes sending, to the UE, the PDSCH as scheduled by the scheduling DCI. In block 410, the method 400 includes receiving, from the UE, a PUCCH comprising HARQ-ACK signaling for the PDSCH once a duration of at least the T_{proc,1} after an end of the PDSCH has passed.

In one embodiment, the method 400 further includes receiving, from the UE, a capability indication message indicating that the UE uses the T_{switch} to calculate the PDSCH processing time, wherein the calculating the T_{proc,1} using the T_{switch} occurs in response to the receiving the capability indication. In one such embodiment, the capability indication indicates that the UE uses the T_{switch} to calculate the PDSCH processing time within a band combination. In another embodiment, the capability indication indicates that the UE always uses the T_{switch} to calculate the PDSCH processing time.

In one embodiment of the method 400, the T_{switch} comprises one of 35 μs, 140 μs, and 210 μs.

Relax PDSCH Processing Time with New Gap

In one embodiment, the PDSCH processing time T_{proc,1} is relaxed using a different amount of time T_{switch}, PDSCH, rather than by using T_{switch}. Herein T_{switch}, PDSCH may be referred to as a “PDSCH UL Tx switch processing time.” In one embodiment, for example, T_{switch}, PDSCH may be added to T_{proc,1} (see, e.g., 3GPP TS 38.214) as:

$${T}_{p r o c , 1} = ( {N}_{1} + {d}_{1.1} + {d}_{2} ) ( 2048 + 1 \; 44 ) \cdot {κ2}^{- μ} \cdot {T}_{c} + {T}_{e x t} + {T}_{s w itch , PDSCH} ,$$

where μ is an index value corresponding to SCS configuration, K is a ratio between Ts and T_{c}. T_{c} is the basic time unit for NR. Ts is the basic time unit for LTE, Text is a cyclic prefix extension, and d_{1,1} and d₂ are relaxation times (symbols).

In certain such embodiments, the value of T_{switch}, PDSCH may be restricted. For example, T_{switch}, PDSCH may be restricted to be less than T_{switch} at least for 15 kHz SCS and 30 kHz SCS, where T_{switch}, may be (e.g., as reported in the uplinkTxSwitchingPeriod-r16 and/or uplinkTxSwitchingPeriod2T2T-r17) one of the candidate values {35 μs, 140 μs, 210 μs}.

In one embodiment, when the PDSCH processing time T_{proc,1} is relaxed using T_{switch}, PDSCH, new UE capability reporting is used to indicate the value of T_{switch}, PDSCH to the base station. The new capability may be reported, for example, as a 3GPP Rel-16 UE capability, a 3GPP Rel-17 UE capability, or a 3GPP Rel-18 UE capability.

In one embodiment, when the PDSCH processing time T_{proc,1} is relaxed using T_{switch,PDSCH}, and new UE capability reporting is used to indicate the value of T_{switch}, PDSCH to the base station, T_{switch}, PDSCH may be reported to be the same value for all possible SCS, or T_{switch,PDSCH} may be reported as different values for different SCS (i.e., T_{switch,PDSCH} has different values for two or more of 15 kHz SCS, 30 kHz SCS, and 60 kHz SCS).

Note that in some embodiments, an SCS that is considered when determining/reporting T_{switch,PDSCH} may be an SCS that applies at a serving cell of one of the scheduling DCI, the PDSCH, and the PUCCH of the UE (e.g., if more than one serving cell is used for these, the SCS of one of the serving cells is used). It is contemplated that in some such cases, the smallest of these SCSs (corresponding to a longer T_{switch,PDSCH}) is considered when determining/reporting T_{switch,PDSCH}.

In one embodiment, when the PDSCH processing time T_{proc,1} is relaxed using T_{switch,PDSCH}, and new UE capability reporting is used to indicate the value of T_{switch,PDSCH} to the base station, the candidate values for T_{switch,PDSCH} may be the same as those for T_{switch} (e.g., {35 μs, 140 μs, 210 μs}). In other cases, the candidate values for T_{switch,PDSCH} may be in a reduced range as compared to those for T_{switch} (e.g., {69 μs, 139 μs}).

In one embodiment, when the PDSCH processing time T_{proc,1} is relaxed using T_{switch,PDSCH}, and new UE capability reporting is used to indicate the value of T_{switch,PDSCH} to the base station, the capability indication message may be per BC and indicates that the UE uses the T_{switch,PDSCH} to calculate the PDSCH processing time within the BC, or the capability indication message may be per UE and indicates whether the UE always uses the T_{switch,PDSCH} to calculate the PDSCH processing time. In certain embodiments, when the UE does not report this capability, the UE does not use relaxation for T_{proc,1}.

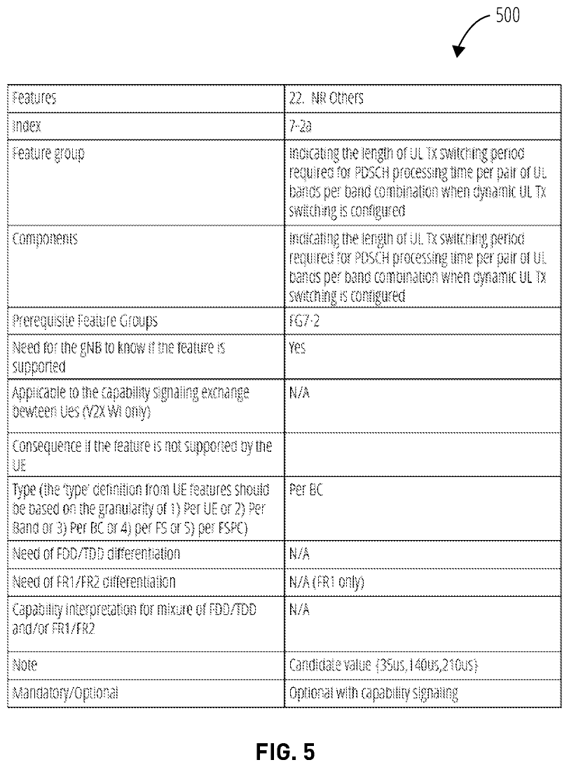

FIG. 5 illustrates a table 500 of UE capability parameters that may be reported by a UE to a base station according to one embodiment. For the reported capability, the illustrated example indicates: features (e.g., for “22. NR Others”); an index (e.g., “7-2a”); a feature group (e.g., indicating the length of UL Tx switching period required for PDSCH processing time per pair of UL bands per band combination when dynamic UL Tx switching is configured); components (e.g., indicating the length of UL Tx switching period required for PDSCH processing time per pair of UL bands per band combination when dynamic UL Tx switching is configured); prerequisite feature groups (e.g., “FG7-2”); whether there is a need for the base station (e.g., gNB) to know if the feature is supported (e.g., Yes); whether the indication is applicable to signaling exchange between UEs (e.g., for V2X implementations) (e.g., not applicable “N/A”); a consequence if the feature is not supported by the UE; a Type (the ‘type’ definition from UE features may be based on the granularity of 1) Per UE or 2) Per Band or 3) Per BC or 4) Per Feature Set (FS) or 5) Per Feature Set Per Component-Carrier (FSPC)) (e.g., per BC); whether there is a need for FDD or TDD differentiation (e.g., N/A); whether there is a need for FR1 or FR2 differentiation (e.g. N/A (FR1 only)); whether there is capability interpretation for FDD/TDD and/or FR1/FR2 (e.g., N/A); Note (which may used to report a value of the T_{switch,PDSCH}) (e.g., {35 μs, 140 μs, 210 μs}, or in other unillustrated cases {69 μs, 139 μs}, etc.); and/or whether the capability is mandatory or optional (e.g., optional with capability signaling).

In one embodiment, for the PDSCH processing time T_{proc,1} relaxed used T_{switch,PDSCH}, T_{switch,PDSCH} is added to T_{proc,1} (see, e.g., 3GPP TS 38.214) as:

$${T}_{p r o c , 1} = ( {N}_{1} + {d}_{1.1} + {d}_{2} ) ( 2048 + 1 \; 44 ) \cdot {κ2}^{- μ} \cdot {T}_{c} + {T}_{e x t} + {T}_{s w itch , PDSCH} ,$$

where T_{switch,PDSCH} is calculated as T_{switch,PDSCH}=T_{switch}, or T_{switch,PDSCH} is determined relative to a reported value of T_{switch}. In one such embodiment, T_{switch,PDSCH}=T_{switch} if the last symbol of the PDSCH is no later than the last symbol of the scheduling DCI, and/or if the first symbol of the PDSCH is no later than the {last symbol+1} of the scheduling DCI and downlink (DL) interruption is reported by UE capability on the band(s) configured for DL and UL Tx switching. Otherwise, T_{switch,PDSCH} is determined relative to the reported value of T_{switch} and the difference is based on one or more of: a DL interruption during switching gap, if reported by UE for the given bands; a duration of the PDSCH; a gap between the last symbol of scheduling DCI and the first symbol of PDSCH; and the numerology (i.e., the SCS) of the scheduling DCI, the numerology of scheduled PDSCH, and the numerology of PUCCH with corresponding HARQ-ACK.

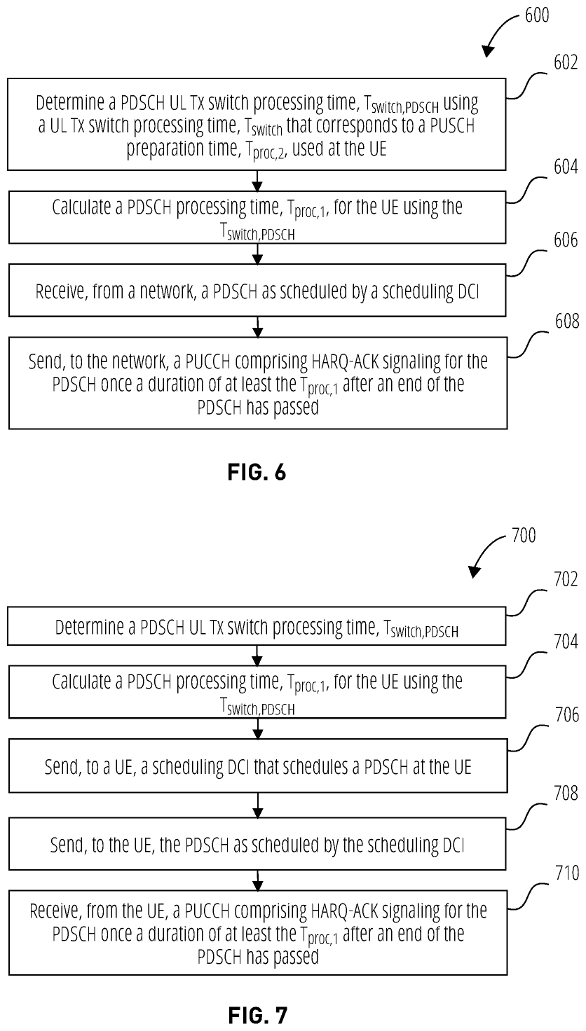

FIG. 6 is a flowchart illustrating a method 600 of a UE according to one embodiment. In block 602, the method 600 includes determining a PDSCH UL Tx switch processing time, T_{switch,PDSCH} using a UL Tx switch processing time, T_{switch} that corresponds to a PUSCH preparation time. T_{proc,2}, used at the UE. In block 604, the method 600 includes calculating a PDSCH processing time, T_{proc,1}, for the UE using the T_{switch,PDSCH}. In block 606, the method 600 includes receiving, from a network, a PDSCH as scheduled by a scheduling DCI. In block 608, the method 600 includes sending, to the network, a PUCCH comprising HARQ-ACK signaling for the PDSCH once a duration of at least the T_{proc,1} after an end of the PDSCH has passed.

In one embodiment, the method 600 further includes sending, to the network, a capability indication message that reports the T_{switch,PDSCH} to the network. In one such embodiment, the capability indication message indicates that the UE uses the T_{switch,PDSCH} to calculate the PDSCH processing time within a band combination. In another embodiment, the capability indication message indicates that the UE always uses the T_{switch,PDSCH} to calculate the PDSCH processing time.

In one embodiment of the method 600, the T_{switch,PDSCH} is determined based on an SCS for one of the scheduling DCI, the PDSCH, and the PUCCH.

In one embodiment of the method 600, each of the T_{switch,PDSCH} and the T_{switch} correspond to a same SCS, and the T_{switch,PDSCH} is less than the T_{switch}.

In one embodiment of the method 600, the T_{switch,PDSCH} comprises one of 69 μs and 139 μs.

In one embodiment of the method 600, the determining the T_{switch,PDSCH} using the T_{switch} includes determining that the T_{switch,PDSCH} is equal to the T_{switch} when one or more of: a first symbol that ends the PDSCH is no later than a second symbol that ends the scheduling DCI; and the first symbol is no later than a third symbol immediately following the second symbol, and the UE is capable of DL interruption on each of one or more bands used for DL Tx switching and UL Tx switching.

In one embodiment of the method 600, the determining the T_{switch,PDSCH} using the T_{switch} includes determining that the T_{switch,PDSCH} is equal to the T_{switch} minus a value that is based on one or more of: a first duration for a DL interruption occurring during a switching gap; a second duration for the PDSCH; a third duration corresponding to a gap between an ending symbol of the scheduling DCI and a beginning symbol of the PDSCH; and each of a first numerology for the scheduling DCI, a second numerology for the PDSCH, and a third numerology of the PUCCH.

FIG. 7 is a flowchart illustrating a method 700 of a RAN according to one embodiment. In block 702, the method 700 includes determining a PDSCH UL Tx switch processing time, T_{switch,PDSCH}. In block 704, the method 700 includes calculating a PDSCH processing time, T_{proc,1}, for the UE using the T_{switch,PDSCH}. In block 706, the method 700 includes sending, to UE, a scheduling DCI that schedules a PDSCH at the UE. In block 708, the method 700 includes sending, to the UE, the PDSCH as scheduled by the scheduling DCI. In block 710, the method 700 includes receiving, from the UE, a PUCCH comprising HARQ-ACK signaling for the PDSCH once a duration of at least the T_{proc,1} after an end of the PDSCH has passed.

In one embodiment, the method 700 further includes receiving, from the UE, a capability indication message that reports the T_{switch,PDSCH} to the network, wherein the T_{switch,PDSCH} is determined at the RAN using the capability indication message. In one such embodiment, the capability indication message indicates that the UE uses the T_{switch,PDSCH} to calculate the PDSCH processing time within a band combination. In another embodiment, the capability indication message indicates that the UE always uses the T_{switch,PDSCH} to calculate the PDSCH processing time.

In one embodiment of the method 700, the T_{switch,PDSCH} is determined using a UL Tx switch processing time, T_{switch} that corresponds to a PUSCH preparation time, T_{proc,2}, used at the UE. The T_{switch,PDSCH} may be determined based on an SCS for one of the scheduling DCI, the PDSCH, and the PUCCH. Each of the T_{switch,PDSCH} and the T_{switch} may correspond to a same SCS and the T_{switch,PDSCH} may be less than the T_{switch}. The T_{switch,PDSCH} may comprise one of 69 μs and 139 μs. In one embodiment, the determining the T_{switch,PDSCH} using the T_{switch} includes determining that the T_{switch,PDSCH} is equal to the T_{switch} when one or more of: a first symbol that ends the PDSCH is no later than a second symbol that ends the scheduling DCI; and the first symbol is no later than a third symbol immediately following the second symbol, and the UE is capable of DL interruption on each of one or more bands used for DL Tx switching and UL Tx switching. In another embodiment, the determining the T_{switch,PDSCH} using the T_{switch} includes determining that the T_{switch,PDSCH} is equal to the T_{switch} minus a value that is based on one or more of: a first duration for a DL interruption occurring during a switching gap; a second duration for the PDSCH; a third duration corresponding to a gap between an ending symbol of the scheduling DCI and a beginning symbol of the PDSCH; and each of a first numerology for the scheduling DCI, a second numerology for the PDSCH, and a third numerology of the PUCCH.

### Additional Example Embodiments

In one embodiment, for UL Tx switching, when HARQ-ACK PUCCH transmission is scheduling for PDSCH scheduled by the dynamic DCI (e.g., DCI Format 1_1/1_2), for a time offset between the end of the scheduling DCI and the beginning of the HARQ-ACK PUCCH, if the time offset is smaller than the PUSCH processing time T_{proc,2}, then the UE may either drop the HARQ-ACK PUCCH or delay the HARQ-ACK PUCCH until the first available slot(s) for PUCCH transmission that satisfies T_{proc,2}.

In one embodiment, for UL Tx switching, additional relaxation is introduced for d_{1,1} in the PDSCH processing time T_{proc,1}. For SCS=15 kHz, when T_{switch}=210 μs, one symbol is added to d_{1,1}. For SCS=30 kHz, when T_{switch}=140 μs, two symbols are added to d_{1,1}, and when T_{switch}=210 μs, four symbols are added to d_{1,1}. For SCS=60 kHz, when T_{switch}=35 μs, four symbols are added to d_{1,1}, when T_{switch}=140 μs, ten symbols are added to d_{1,1}, and when T_{switch}=210 μs, fourteen symbols are added to d_{1,1}.

Note that in some embodiments, an SCS that is considered when determining a number of additional symbols to add to d_{1,1} may be an SCS that applies at a serving cell of one of the scheduling DCI, the PDSCH, and the PUCCH of the UE (e.g., if more than one serving cell is used for these, the SCS of one of the serving cells is used). It is contemplated that in some such cases, the smallest of these SCSs (corresponding to more additional symbols added to d_{1,1}) is considered when determining a number of additional symbols to add to d_{1,1}.

In one embodiment, for UL Tx switching, when additional relaxation is introduced for din in the PDSCH processing time T_{proc,1}, the relaxation may only be introduced for certain cases depending on: the time domain resource allocation (TDRA) mapping type of the PDSCH; whether mapping type A or mapping type B is used; the duration of the scheduled PDSCH; and/or how many symbols of the PDSCH overlaps with the scheduling DCI.

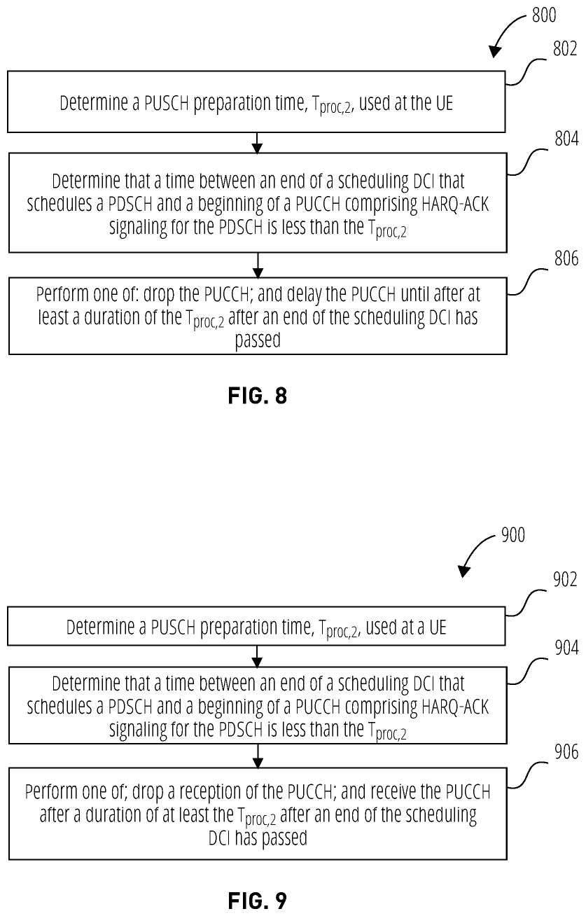

FIG. 8 is a flowchart illustrating a method 800 of a UE according to one embodiment. In block 802, the method 800 includes determining a PUSCH preparation time, T_{proc,2}, used at the UE. In block 804, the method 800 includes determining that a time between an end of a scheduling DCI that schedules a PDSCH and a beginning of a PUCCH comprising HARQ-ACK signaling for the PDSCH is less than the T_{proc,2}. In block 806, method 800 performs one of: dropping the PUCCH; and delaying the PUCCH until after at least a duration of the T_{proc,2} after an end of the scheduling DCI has passed.

FIG. 9 is a flowchart illustrating a method 900 of a RAN according to one embodiment. In block 902, the method 900 includes determining a PUSCH preparation time, T_{proc,2}, used at a UE. In block 904, the method 900 includes determining that a time between an end of a scheduling DCI that schedules a PDSCH and a beginning of a PUCCH comprising HARQ-ACK signaling for the PDSCH is less than the T_{proc,2}. In block 906, the method 900 performs one of: dropping a reception of the PUCCH; and receiving the PUCCH after a duration of at least the T_{proc,2} after an end of the scheduling DCI has passed.

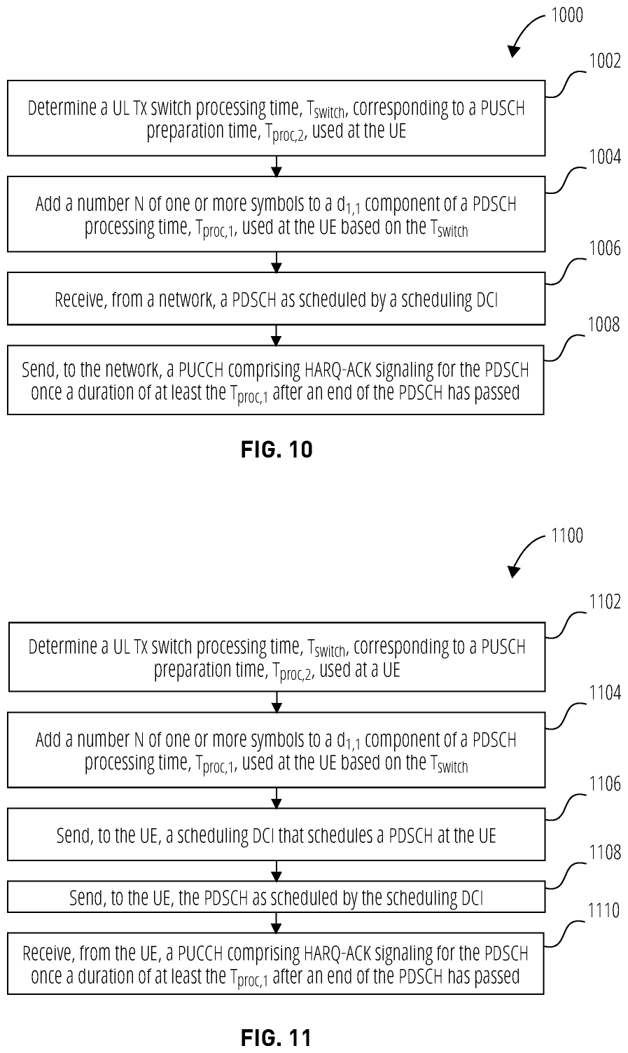

FIG. 10 is a flowchart illustrating a method 1000 of a UE according to one embodiment. In block 1002, the method 1000 includes determining a UL Tx switch processing time, T_{switch}, corresponding to a PUSCH preparation time, T_{proc,2}, used at the UE. In block 1004, the method 1000 includes adding a number N of one or more symbols to a d_{1,1} component of a PDSCH processing time, T_{proc,1}, used at the UE based on the T_{switch}. In block 1006, the method 1000 includes receiving, from a network, a PDSCH as scheduled by a scheduling DCI. In block 1008, the method 1000 includes sending, to the network, a PUCCH comprising HARQ-ACK signaling for the PDSCH once a duration of at least the T_{proc,1} after an end of the PDSCH has passed.

In one embodiment of the method 1000, an SCS for one of the scheduling DCI, the PDSCH, and the PUCCH is 15 kHz, the T_{switch} is equal to 210 μs, and the number of symbols N is one.

In one embodiment of the method 1000, an SCS for one of the scheduling DCI, the PDSCH, and the PUCCH is 30 kHz, and one of: the T_{switch} is equal to 140 μs and the number of symbols N is two; and the T_{switch} is equal to 210 μs and the number of symbols N is four.

In one embodiment of the method 1000, an SCS for one of the scheduling DCI, the PDSCH, and the PUCCH is 60 kHz, and one of: the T_{switch} is equal to 35 μs and the number of symbols N is four; the T_{switch} is equal to 140 μs and the number of symbols N is 10; and the T_{switch} is equal to 210 μs and the number of symbols Nis 14.

In one embodiment of the method 1000, the adding the number N of the one or more symbols to the d_{1,1} component of the T_{proc,1} occurs in response to a determination of one of: that a TDRA mapping type of the PDSCH corresponds to a use of the number N of the one or more symbols in the d_{1,1} component; that a duration of the PDSCH corresponds to the use of the number N of the one or more symbols in the d_{1,1} component; and that a number M of symbols within the PDSCH that overlap with the scheduling DCI corresponds to the use of the number N of the one or more symbols in the d_{1,1} component.

FIG. 11 is a flowchart illustrating a method 1000 of a RAN according to one embodiment. In block 1102, the method 1100 includes determining a UL Tx switch processing time, T_{switch}, corresponding to a PUSCH preparation time, T_{proc,2}, used at a UE. In block 1104, the method 1100 includes adding a number N of one or more symbols to a d_{1,1} component of a PDSCH processing time, T_{proc,1}, used at the UE based on the T_{switch}. In block 1106, the method 1100 includes sending, to the UE, a scheduling DCI that schedules a PDSCH at the UE. In block 1108, the method 1100 includes sending, to the UE, the PDSCH as scheduled by the scheduling DCI. In block 1110, the method 1100 includes receiving, from the UE, a PUCCH comprising HARQ-ACK signaling for the PDSCH once a duration of at least the T_{proc,1} after an end of the PDSCH has passed.

In one embodiment of the method 1100, an SCS for one of the scheduling DCI, the PDSCH, and the PUCCH is 15 kHz, the T_{switch} is equal to 210 μs, and the number of symbols N is one.

In one embodiment of the method 1100, an SCS for one of the scheduling DCI, the PDSCH, and the PUCCH is 30 kHz, and wherein one of: the T_{switch} is equal to 140 μs and the number of symbols N is two; and the T_{switch} is equal to 210 μs and the number of symbols N is four.

In one embodiment of the method 1100, an SCS for one of the scheduling DCI, the PDSCH, and the PUCCH is 60 kHz; and wherein one of: the T_{switch} is equal to 35 μs and the number of symbols N is four; the T_{switch} is equal to 140 μs and the number of symbols Nis 10; and the T_{switch} is equal to 210 μs and the number of symbols Nis 14.

In one embodiment of the method 1100, the adding the number N of the one or more symbols to the d_{1,1} component of the T_{proc,1} occurs in response to a determination of one of: that a TDRA mapping type of the PDSCH corresponds to a use of the number N of the one or more symbols in the d_{1,1} component; that a duration of the PDSCH corresponds to the use of the number N of the one or more symbols in the d_{1,1} component; and that a number M of symbols within the PDSCH that overlap with the scheduling DCI corresponds to the use of the number N of the one or more symbols in the d_{1,1} component.

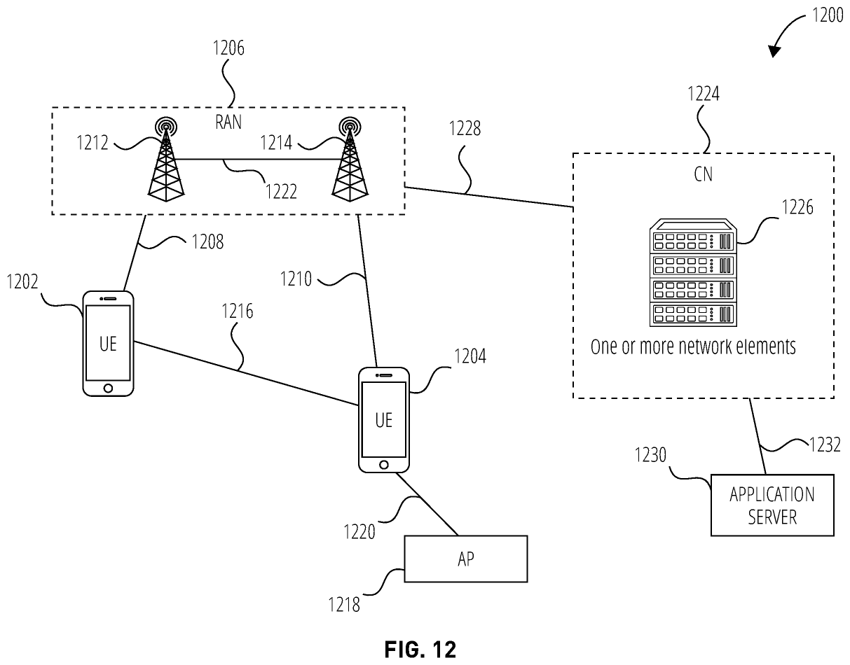

FIG. 12 illustrates an example architecture of a wireless communication system 1200, according to embodiments disclosed herein. The following description is provided for an example wireless communication system 1200 that operates in conjunction with the LTE system standards and/or 5G or NR system standards as provided by 3GPP technical specifications.

As shown by FIG. 12, the wireless communication system 1200 includes UE 1202 and UE 1204 (although any number of UEs may be used). In this example, the UE 1202 and the UE 1204 are illustrated as smartphones (e.g., handheld touchscreen mobile computing devices connectable to one or more cellular networks), but may also comprise any mobile or non-mobile computing device configured for wireless communication.

The UE 1202 and UE 1204 may be configured to communicatively couple with a RAN 1206. In embodiments, the RAN 1206 may be NG-RAN, E-UTRAN, etc. The UE 1202 and UE 1204 utilize connections (or channels) (shown as connection 1208 and connection 1210, respectively) with the RAN 1206, each of which comprises a physical communications interface. The RAN 1206 can include one or more base stations (such as base station 1212 and base station 1214) that enable the connection 1208 and connection 1210.

In this example, the connection 1208 and connection 1210 are air interfaces to enable such communicative coupling, and may be consistent with RAT(s) used by the RAN 1206, such as, for example, an LTE and/or NR.

In some embodiments, the UE 1202 and UE 1204 may also directly exchange communication data via a sidelink interface 1216. The UE 1204 is shown to be configured to access an access point (shown as AP 1218) via connection 1220. By way of example, the connection 1220 can comprise a local wireless connection, such as a connection consistent with any IEEE 802.11 protocol, wherein the AP 1218 may comprise a Wi-Fi® router. In this example, the AP 1218 may be connected to another network (for example, the Internet) without going through a CN 1224.

In embodiments, the UE 1202 and UE 1204 can be configured to communicate using orthogonal frequency division multiplexing (OFDM) communication signals with each other or with the base station 1212 and/or the base station 1214 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1212 or base station 1214 may be implemented as one or more software entities running on server computers as part of a virtual network. In addition, or in other embodiments, the base station 1212 or base station 1214 may be configured to communicate with one another via interface 1222. In embodiments where the wireless communication system 1200 is an LTE system (e.g., when the CN 1224 is an EPC), the interface 1222 may be an X2 interface. The X2 interface may be defined between two or more base stations (e.g., two or more eNBs and the like) that connect to an EPC, and/or between two eNBs connecting to the EPC. In embodiments where the wireless communication system 1200 is an NR system (e.g., when CN 1224 is a 5GC), the interface 1222 may be an Xn interface. The Xn interface is defined between two or more base stations (e.g., two or more gNBs and the like) that connect to 5GC, between a base station 1212 (e.g., a gNB) connecting to 5GC and an eNB, and/or between two eNBs connecting to 5GC (e.g., CN 1224).

The RAN 1206 is shown to be communicatively coupled to the CN 1224. The CN 1224 may comprise one or more network elements 1226, which are configured to offer various data and telecommunications services to customers/subscribers (e.g., users of UE 1202 and UE 1204) who are connected to the CN 1224 via the RAN 1206. The components of the CN 1224 may be implemented in one physical device or separate physical devices including components to read and execute instructions from a machine-readable or computer-readable medium (e.g., a non-transitory machine-readable storage medium).

In embodiments, the CN 1224 may be an EPC, and the RAN 1206 may be connected with the CN 1224 via an S1 interface 1228. In embodiments, the S1 interface 1228 may be split into two parts, an S1 user plane (S1-U) interface, which carries traffic data between the base station 1212 or base station 1214 and a serving gateway (S-GW), and the S1-MME interface, which is a signaling interface between the base station 1212 or base station 1214 and mobility management entities (MMEs).

In embodiments, the CN 1224 may be a 5GC, and the RAN 1206 may be connected with the CN 1224 via an NG interface 1228. In embodiments, the NG interface 1228 may be split into two parts, an NG user plane (NG-U) interface, which carries traffic data between the base station 1212 or base station 1214 and a user plane function (UPF), and the S1 control plane (NG-C) interface, which is a signaling interface between the base station 1212 or base station 1214 and access and mobility management functions (AMFs).

Generally, an application server 1230 may be an element offering applications that use internet protocol (IP) bearer resources with the CN 1224 (e.g., packet switched data services). The application server 1230 can also be configured to support one or more communication services (e.g., VoIP sessions, group communication sessions, etc.) for the UE 1202 and UE 1204 via the CN 1224. The application server 1230 may communicate with the CN 1224 through an IP communications interface 1232.

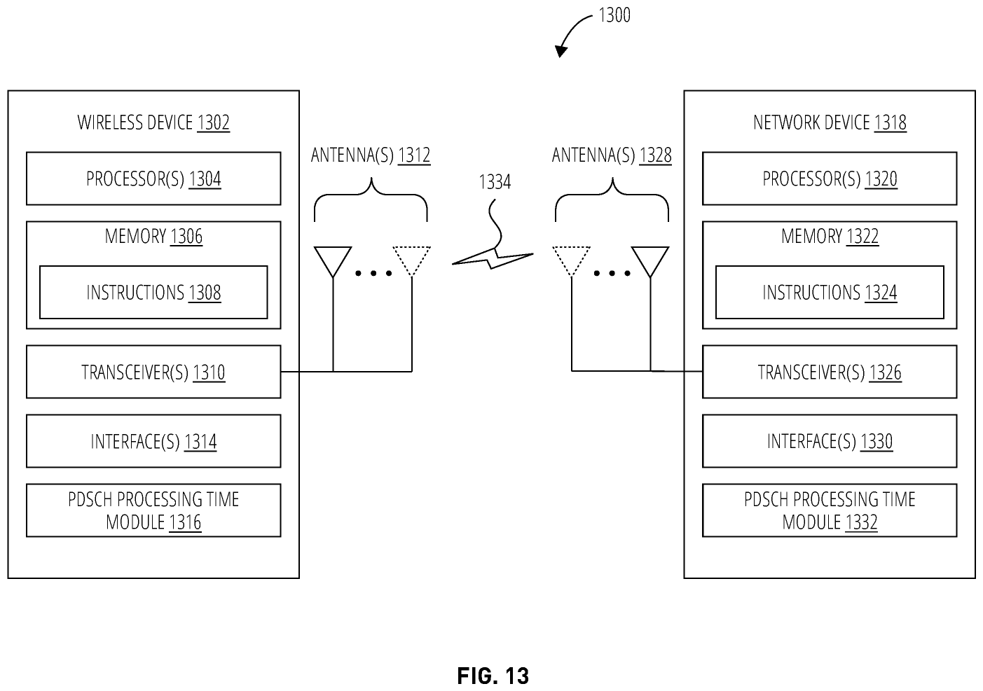

FIG. 13 illustrates a system 1300 for performing signaling 1334 between a wireless device 1302 and a network device 1318, according to embodiments disclosed herein. The system 1300 may be a portion of a wireless communications system as herein described. The wireless device 1302 may be, for example, a UE of a wireless communication system. The network device 1318 may be, for example, a base station (e.g., an eNB or a gNB) of a wireless communication system.

The wireless device 1302 may include one or more processor(s) 1304. The processor(s) 1304 may execute instructions such that various operations of the wireless device 1302 are performed, as described herein. The processor(s) 1304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1302 may include a memory 1306. The memory 1306 may be a non-transitory computer-readable storage medium that stores instructions 1308 (which may include, for example, the instructions being executed by the processor(s) 1304). The instructions 1308 may also be referred to as program code or a computer program. The memory 1306 may also store data used by, and results computed by, the processor(s) 1304.

The wireless device 1302 may include one or more transceiver(s) 1310 that may include radio frequency (RF) transmitter and/or receiver circuitry that use the antenna(s) 1312 of the wireless device 1302 to facilitate signaling (e.g., the signaling 1334) to and/or from the wireless device 1302 with other devices (e.g., the network device 1318) according to corresponding RATs.

The wireless device 1302 may include one or more antenna(s) 1312 (e.g., one, two, four, or more). For embodiments with multiple antenna(s) 1312, the wireless device 1302 may leverage the spatial diversity of such multiple antenna(s) 1312 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1302 may be accomplished according to precoding (or digital beamforming) that is applied at the wireless device 1302 that multiplexes the data streams across the antenna(s) 1312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1302 may implement analog beamforming techniques, whereby phases of the signals sent by the antenna(s) 1312 are relatively adjusted such that the (joint) transmission of the antenna(s) 1312 can be directed (this is sometimes referred to as beam steering).

The wireless device 1302 may include one or more interface(s) 1314. The interface(s) 1314 may be used to provide input to or output from the wireless device 1302. For example, a wireless device 1302 that is a UE may include interface(s) 1314 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1310/antenna(s) 1312 already described) that allow for communication between the UE and other devices and may operate according to known protocols (e.g., Wi-Fi®, Bluetooth®, and the like).

The wireless device 1302 may include a PDSCH processing time module 1316. The PDSCH processing time module 1316 may be implemented via hardware, software, or combinations thereof. For example, the PDSCH processing time module 1316 may be implemented as a processor, circuit, and/or instructions 1308 stored in the memory 1306 and executed by the processor(s) 1304. In some examples, the PDSCH processing time module 1316 may be integrated within the processor(s) 1304 and/or the transceiver(s) 1310. For example, the PDSCH processing time module 1316 may be implemented by a combination of software components (e.g., executed by a DSP or a general processor) and hardware components (e.g., logic gates and circuitry) within the processor(s) 1304 or the transceiver(s) 1310.

The PDSCH processing time module 1316 may be used for various aspects of the present disclosure, for example, aspects of FIG. 2, FIG. 3, FIG. 5, FIG. 6, FIG. 8, and/or FIG. 10.

The network device 1318 may include one or more processor(s) 1320. The processor(s) 1320 may execute instructions such that various operations of the network device 1318 are performed, as described herein. The processor(s) 1320 may include one or more baseband processors implemented using, for example, a CPU, a DSP, an ASIC, a controller, an FPGA device, another hardware device, a firmware device, or any combination thereof configured to perform the operations described herein.

The network device 1318 may include a memory 1322. The memory 1322 may be a non-transitory computer-readable storage medium that stores instructions 1324 (which may include, for example, the instructions being executed by the processor(s) 1320). The instructions 1324 may also be referred to as program code or a computer program. The memory 1322 may also store data used by, and results computed by, the processor(s) 1320.

The network device 1318 may include one or more transceiver(s) 1326 that may include RF transmitter and/or receiver circuitry that use the antenna(s) 1328 of the network device 1318 to facilitate signaling (e.g., the signaling 1334) to and/or from the network device 1318 with other devices (e.g., the wireless device 1302) according to corresponding RATs.

The network device 1318 may include one or more antenna(s) 1328 (e.g., one, two, four, or more). In embodiments having multiple antenna(s) 1328, the network device 1318 may perform MIMO, digital beamforming, analog beamforming, beam steering, etc., as has been described.

The network device 1318 may include one or more interface(s) 1330. The interface(s) 1330 may be used to provide input to or output from the network device 1318. For example, a network device 1318 that is a base station may include interface(s) 1330 made up of transmitters, receivers, and other circuitry (e.g., other than the transceiver(s) 1326/antenna(s) 1328 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1318 may include a PDSCH processing time module 1332. The PDSCH processing time module 1332 may be implemented via hardware, software, or combinations thereof. For example, the PDSCH processing time module 1332 may be implemented as a processor, circuit, and/or instructions 1324 stored in the memory 1322 and executed by the processor(s) 1320. In some examples, the PDSCH processing time module 1332 may be integrated within the processor(s) 1320 and/or the transceiver(s) 1326. For example, the PDSCH processing time module 1332 may be implemented by a combination of software components (e.g., executed by a DSP or a general processor) and hardware components (e.g., logic gates and circuitry) within the processor(s) 1320 or the transceiver(s) 1326.

The PDSCH processing time module 1332 may be used for various aspects of the present disclosure, for example, aspects of FIG. 2, FIG. 4, FIG. 5, FIG. 7, FIG. 9, and/or FIG. 11.

Embodiments contemplated herein include an apparatus comprising means to perform one or more elements of the method 300, the method 600, the method 800, and/or the method 1000. This apparatus may be, for example, an apparatus of a UE (such as a wireless device 1302 that is a UE, as described herein).

Embodiments contemplated herein include one or more non-transitory computer-readable media comprising instructions to cause an electronic device, upon execution of the instructions by one or more processors of the electronic device, to perform one or more elements of the method 300, the method 600, the method 800, and/or the method 1000. This non-transitory computer-readable media may be, for example, a memory of a UE (such as a memory 1306 of a wireless device 1302 that is a UE, as described herein).

Embodiments contemplated herein include an apparatus comprising logic, modules, or circuitry to perform one or more elements of the method 300, the method 600, the method 800, and/or the method 1000. This apparatus may be, for example, an apparatus of a UE (such as a wireless device 1302 that is a UE, as described herein).

Embodiments contemplated herein include an apparatus comprising: one or more processors and one or more computer-readable media comprising instructions that, when executed by the one or more processors, cause the one or more processors to perform one or more elements of the method 300, the method 600, the method 800, and/or the method 1000. This apparatus may be, for example, an apparatus of a UE (such as a wireless device 1302 that is a UE, as described herein).

Embodiments contemplated herein include a signal as described in or related to one or more elements of the method 300, the method 600, the method 800, and/or the method 1000.

Embodiments contemplated herein include a computer program or computer program product comprising instructions, wherein execution of the program by a processor is to cause the processor to carry out one or more elements of the method 300, the method 600, the method 800, and/or the method 1000. The processor may be a processor of a UE (such as a processor(s) 1304 of a wireless device 1302 that is a UE, as described herein). These instructions may be, for example, located in the processor and/or on a memory of the UE (such as a memory 1306 of a wireless device 1302 that is a UE, as described herein).

Embodiments contemplated herein include an apparatus comprising means to perform one or more elements of the method 400, the method 700, the method 900, and/or the method 1100. This apparatus may be, for example, an apparatus of a base station (such as a network device 1318 that is a base station, as described herein).

Embodiments contemplated herein include one or more non-transitory computer-readable media comprising instructions to cause an electronic device, upon execution of the instructions by one or more processors of the electronic device, to perform one or more elements of the method 400, the method 700, the method 900, and/or the method 1100. This non-transitory computer-readable media may be, for example, a memory of a base station (such as a memory 1322 of a network device 1318 that is a base station, as described herein).

Embodiments contemplated herein include an apparatus comprising logic, modules, or circuitry to perform one or more elements of the method 400, the method 700, the method 900, and/or the method 1100. This apparatus may be, for example, an apparatus of a base station (such as a network device 1318 that is a base station, as described herein).

Embodiments contemplated herein include an apparatus comprising: one or more processors and one or more computer-readable media comprising instructions that, when executed by the one or more processors, cause the one or more processors to perform one or more elements of the method 400, the method 700, the method 900, and/or the method 1100. This apparatus may be, for example, an apparatus of a base station (such as a network device 1318 that is a base station, as described herein).

Embodiments contemplated herein include a signal as described in or related to one or more elements of the method 400, the method 700, the method 900, and/or the method 1100.

Embodiments contemplated herein include a computer program or computer program product comprising instructions, wherein execution of the program by a processing element is to cause the processing element to carry out one or more elements of the method 400, the method 700, the method 900, and/or the method 1100. The processor may be a processor of a base station (such as a processor(s) 1320 of a network device 1318 that is a base station, as described herein). These instructions may be, for example, located in the processor and/or on a memory of the base station (such as a memory 1322 of a network device 1318 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
determining an uplink (UL) transmit (Tx) switch processing time, T_{switch}, corresponding to a physical uplink shared channel (PUSCH) preparation time, T_{proc,2}, used at the UE;
calculating a physical downlink shared channel (PDSCH) processing time, T_{proc,1}, for the UE using the T_{switch};
receiving, from a network, a PDSCH as scheduled by a scheduling downlink control information (DCI); and
sending, to the network, a physical uplink control channel (PUCCH) comprising hybrid automatic repeat request acknowledgement (HARQ-ACK) signaling for the PDSCH once a duration of at least the T_{proc,1} after an end of the PDSCH has passed.

2. The method of claim 1, further comprising sending, to the network, a capability indication message indicating that the UE uses the T_{switch} to calculate the PDSCH processing time.

3. The method of claim 2, wherein the capability indication message indicates that the UE uses the T_{switch} to calculate the PDSCH processing time within a band combination.

4. The method of claim 2, wherein the capability indication message indicates that the UE always uses the T_{switch} to calculate the PDSCH processing time.

5. The method of claim 1, wherein the T_{switch} comprises one of 35 microseconds (μs), 140 μs, and 210 μs.

6. A method of a radio access network (RAN), comprising:
determining an uplink (UL) transmit (Tx) switch processing time, T_{switch}, corresponding to a physical uplink shared channel (PUSCH) preparation time, T_{proc,2}, used at a user equipment (UE);
calculating a physical downlink shared channel (PDSCH) processing time, T_{proc,1}, for the UE using the T_{switch};
sending, to the UE, a scheduling downlink control information (DCI) that schedules a PDSCH at the UE;
sending, to the UE, the PDSCH as scheduled by the scheduling DCI; and
receiving, from the UE, a physical uplink control channel (PUCCH) comprising hybrid automatic repeat request acknowledgement (HARQ-ACK) signaling for the PDSCH once a duration of at least the T_{proc,1} after an end of the PDSCH has passed.

7. The method of claim 6, further comprising receiving, from the UE, a capability indication message indicating that the UE uses the T_{switch} to calculate the PDSCH processing time, wherein the calculating the T_{proc,1} using the T_{switch} occurs in response to the receiving the capability indication.

8. The method of claim 7, wherein the capability indication indicates that the UE uses the T_{switch} to calculate the PDSCH processing time within a band combination.

9. The method of claim 7, wherein the capability indication indicates that the UE always uses the T_{switch} to calculate the PDSCH processing time.

10. The method of claim 6, wherein the T_{switch} comprises one of 35 microseconds (μs), 140 μs, and 210 μs.

11. A method of a user equipment (UE), comprising:
determining a physical downlink shared channel (PDSCH) uplink (UL) transmit (Tx) switch processing time, T_{switch,PDSCH} using a UL Tx switch processing time, T_{switch} that corresponds to a physical uplink shared channel (PUSCH) preparation time, T_{proc,2}, used at the UE;
calculating a PDSCH processing time, T_{proc,1}, for the UE using the T_{switch,PDSCH}, receiving, from a network, a PDSCH as scheduled by a scheduling downlink control information (DCI); and
sending, to the network, a physical uplink control channel (PUCCH) comprising hybrid automatic repeat request acknowledgement (HARQ-ACK) signaling for the PDSCH once a duration of at least the T_{proc,1} after an end of the PDSCH has passed.

12. The method of claim 11, further comprising sending, to the network, a capability indication message that reports the T_{switch,PDSCH} to the network.

13. The method of claim 12, wherein the capability indication message indicates that the UE uses the T_{switch,PDSCH} to calculate the PDSCH processing time within a band combination.

14. The method of claim 12, wherein the capability indication message indicates that the UE always uses the T_{switch,PDSCH} to calculate the PDSCH processing time.

15. The method of claim 11, wherein the T_{switch,PDSCH} is determined based on a subcarrier spacing (SCS) for one of the scheduling DCI, the PDSCH, and the PUCCH.

16. The method of claim 11, wherein:
each of the T_{switch,PDSCH} and the T_{switch} correspond to a same subcarrier spacing (SCS); and
the T_{switch,PDSCH} is less than the T_{switch}.

17. The method of claim 11, wherein the T_{switch,PDSCH} comprises one of 69 microseconds (μs) and 139 μs.

18. The method of claim 11, wherein the determining the T_{switch,PDSCH} using the T_{switch} comprises determining that the T_{switch,PDSCH} is equal to the T_{switch} when one or more of:
a first symbol that ends the PDSCH is no later than a second symbol that ends the scheduling DCI; and
the first symbol is no later than a third symbol immediately following the second symbol, and the UE is capable of downlink (DL) interruption on each of one or more bands used for DL Tx switching and UL Tx switching.

19. The method of claim 11, wherein the determining the T_{switch,PDSCH} using the T_{switch} comprises determining that the T_{switch,PDSCH} is equal to the T_{switch} minus a value that is based on one or more of:
a first duration for a downlink (DL) interruption occurring during a switching gap;
a second duration for the PDSCH;
a third duration corresponding to a gap between an ending symbol of the scheduling DCI and a beginning symbol of the PDSCH; and
each of a first numerology for the scheduling DCI, a second numerology for the PDSCH, and a third numerology of the PUCCH.

20-32. (canceled)
